(19) United States
(12) Patent Application Publication
(10) Pub. No.: US 2014/0280186 A1
(43) Pub. Date: Sep. 18, 2014

(54) CROWDSOURCING AND CONSOLIDATING USER NOTES TAKEN IN A VIRTUAL MEETING

(71) Applicant: INTERNATIONAL BUSINESS MACHINES CORPORATION, (US)

(72) Inventors: Edwin W. Peters, Irving, TX (US); Sherry L. Platek, Clarksville, TN (US); Nitty T. Pulikan, Irving, TX (US); Balaji Ranganathan, Plano, TX (US); Liviu Rodean, Hilliard, OH (US); Balasubramanian Sivasubramanian, Austin, TX (US); Eric Woods, Durham, NC (US)

(73) Assignee: INTERNATIONAL BUSINESS MACHINES CORPORATION, Armonk, NY (US)

(21) Appl. No.: 13/838,731

(22) Filed: Mar. 15, 2013

(51) Int. Cl. G06F 17/30

(52) U.S. Cl. CPC G06F 17/30613
USPC 707/741; 707/736

(57) ABSTRACT

Arrangements relate to crowdsourcing and consolidating user notes taken within a virtual meeting. Notes from one or more meeting attendees can be received. The received user notes can be analyzed to identify a key element therein using natural language processing. The analysis of received user notes can be performed by a processor. A consolidated system notes can be generated. The consolidated system notes can include the key element.

### BACKGROUND

Arrangements described herein relate to note taking within a virtual meeting.

Advances in communications and information technology have allowed for greater collaboration and streamlined processes within an organization. As a result, the need for an individual's physical presence has been reduced in at least some situations. For instance, meetings between two or more individuals are a regular part of any organizational environment. When meeting participants are located in different locations, an in-person meeting may not be practical. Instead, a meeting can be conducted virtually such that the two or more participants interact with one another remotely.

During a virtual meeting, users may manually take notes to reflect their understanding of the discussion and important concepts. Each user's note-taking is done independently of other note takers and the notes are not shared. Thus, if there are five meeting attendees who take notes, then there are five separate sets of notes at the end of the meeting and the notes are not shared. Consequently, the value of the notes is confined to the original note taker.

### BRIEF SUMMARY

One or more embodiments disclosed within this specification relate to note taking in a virtual meetings and, more particularly, to crowdsourcing and consolidating user notes taken in a virtual meeting.

An embodiment can include a method of crowdsourcing and consolidating user notes taken within a virtual meeting. The method can include receiving user notes from one or more virtual meeting attendees. The method can further include, via a processor, analyzing the received user notes to identify a key element in the user notes. Such analyzing can be performed using natural language processing. The method can also include generating consolidated system notes that includes the key element.

Another embodiment can include a system for crowdsourcing and consolidating user notes taken within a virtual meeting. The system can have a processor. The processor can be configured to initiate executable operations. The executable operations can include receiving user notes from one or more meeting attendees. Further, the executable operations can include analyzing the received user notes to identify a key element therein. Such analyzing can include using natural language processing. The executable operations can further include generating consolidated system notes that includes the key element.

Another embodiment can include a computer program product for crowdsourcing and consolidating user notes taken within a virtual meeting. The computer program product can include a computer-readable storage medium having stored thereon program code that, when executed, configures a processor to perform a method. The method can include, by the processor, receiving user notes from one or more meeting attendees. The method can further include, by the processor, analyzing the received user notes to identify a key element therein. The analyzing can include using natural language processing. The method can also include, by the processor, cross-referencing the analysis of each meeting attendee's notes to identify common key elements. Further, the method can include generating, by the processor, consolidated system notes that includes the key element

### BRIEF DESCRIPTION OF THE SEVERAL VIEWS OF THE DRAWINGS

FIG. 1 is a block diagram illustrating a system for crowdsourcing and consolidating user notes taken in a virtual meeting in accordance with one embodiment disclosed within this specification.

FIG. 2 is a flow chart illustrating a method crowdsourcing and consolidating user notes taken in a virtual meeting in accordance with one embodiment disclosed within this specification.

FIG. 3 is a block diagram illustrating a system for crowdsourcing and consolidating user notes taken in a virtual meeting in accordance with one embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

FIG. 1 depicts a block diagram illustrating a system 100 for crowdsourcing and consolidating user notes taken in a virtual meeting in accordance with one embodiment disclosed within this specification. A virtual meeting can be a virtual environment in which two or more virtually represented attendees (e.g. persons) can communicate using a communication network. Examples of ways in which virtual meetings can occur include teleconferences, web-conferencing, online collaboration, instant messaging, video conferencing, voice conferencing, desktop/computer sharing. A virtual meeting can include a plurality of meeting attendees, which can include the meeting chair(s), meeting presenter(s), and meeting participant(s). In the virtual meeting, two or more virtually represented attendees can communicate audio, video, graphics, images, data, file documents, texts, etc. A virtual meeting can be implemented for a meeting in which at least some of the attendees are physically located within the same location, room, or meeting place. In some instances, a virtual meeting can be implemented for a meeting in which at least at least some of the meeting attendees are located remotely from each other, thereby allowing the meeting attendees to interact with one another remotely. In the present application, crowdsourcing is the collection, development and/or creation of notes, data, items or content using inputs received from a plurality of attendees of a virtual meeting.

The system 100 can include one or more clients 105 and one or more servers 110. The system 100 further can include a virtual meeting module 120, an analysis engine 125 and a meeting database 130. While the virtual meeting module 120, the analysis engine 125 and the meeting database 130 are shown in FIG. 1 as being components of the sever 110, it will be understood that one or more of these items can be executed on and/or distributed among other processing systems to which the server 110 is communicatively linked.

The various components of system 100 can be communicatively linked through one or more communication networks 115. As used herein, the term “communicatively linked” can include direct or indirect connections through a communication channel or pathway or another component or system. A “communication network” means one or more components designed to facilitate the delivery of information from one source to another.

The one or more communication networks 115 can be implemented as, or include, without limitation, a wide area network (WAN), wireless wide area network (WWAN), a local area network (LAN), wireless local area network (WLAN), the Internet, the Public Switched Telephone Network (PSTN), a wireless network, a mobile network, a Virtual Private Network (VPN), the Internet, and/or one or more intranets. The communication network(s) 115 can include any combination of the above networks and/or other types of networks. The communication network(s) 115 can include one or more routers, switches, access points, wireless access points, and/or the like.

The system 100 can include one or more meeting clients 105 used by one or more users. The meeting client(s) 105 can be implemented as any of a variety of communication devices executing suitable communication software. The meeting client(s) can be any suitable device that can allow a user to access a virtual meeting. Each meeting client 105 can be implemented as a computer system or other information processing system. One or more of the meeting clients 105 may also be implemented as a portable or mobile computing device, e.g., a mobile telephone, a smart phone, a wireless-enabled personal digital assistant, a portable computer, e.g., laptop, tablet or the like.

Each client 105 can include and/or execute suitable communication software, which enables the client 105 to communicate with the server 110 and/or other clients 105 through the communication network 115 and perform the functions disclosed herein. For instance, the meeting client(s) 105 can be an IM client, an electronic mail client, an SMS client, a system client, a telecommunication system client, a telephone client (e.g. Voice over Internet Protocol (VoIP) system), videoconference client, etc. In some instances, the one or more meeting client(s) 105 can be configured to communicate via a wireless and/or wired medium.

The system 100 can include one or more servers 110, which can be communicatively linked to the one or more meeting clients 105 via one or more communication networks 115. The one or more servers 110 can be implemented as, for example, a virtual meeting system. In this regard, the one or more servers 110 can be implemented as a virtual meeting server or other communication hub or server capable of executing a virtual meeting within or as part of the communication network 115. In any case, the one or more servers 110 can include suitable operational software for performing the various functions described herein.

The system 100 can include a virtual meeting module 120 and a meeting database 130. The virtual meeting module 120 and/or the meeting database 130 can be stored and/or executed on the server 110. Alternatively, the virtual meeting module 120 and/or the meeting database 130 can be stored and/or executed on another system to which the server 110 is communicatively linked. As an example, the virtual meeting module 120 and/or the meeting database can be stored and/or executed on one or more of the meeting clients 105.

The virtual meeting module 120 can be implemented as computer readable program code that, when executed by a processor, implement the various processes described herein. The virtual meeting module 120 can facilitate the conducting of a virtual meeting in various ways. For instance, the virtual meeting module 120 can start, conduct, and/or terminate the virtual meeting session. The virtual meeting module 120 can process data to identify attendees, data related to a presentation within the virtual meeting, data related to a meeting topic within the virtual meeting, a need for a virtual meeting, provide agenda tracking, identify the meeting clients used by attendees to communicate with the virtual meeting. The virtual meeting module 120 can provide automated data archiving, capture during the virtual meeting that can track virtual meeting minutes.

The virtual meeting module 120 can allow users to participate in the virtual meeting via any suitable means. For instance, meeting attendees can submit meeting content 140 to and receive meeting content 140 from the virtual meeting. The meeting content 140 can include, for example, messaging (e.g. chat, instant messaging), video and/or audio data. The meeting content 140 can be transmitted across one or more channels or streams. The virtual meeting module 120 can record data transmitted across these meeting content channels or streams.

The virtual meeting module 120 can be configured to allow meeting attendees to input user notes 135 during the course of the virtual meeting. For instance, one or more user interface elements can be presented to the virtual meeting attendees to enable a user to input the user notes 135. As used herein, a “user interface element” is defined as a component or a group of components that enables a user to interact with a machine. The user notes 135 can be input in any suitable form. In one implementation, the user notes 135 can be input as text. Alternatively or in addition, the user notes can be input as video and/or audio data.

In one implementation, the user notes 135 can be designated as being confidential. That is, the user notes 135 received from one meeting attendee are not shared or otherwise made available to other meeting attendees. In one arrangement, the virtual meeting module 120 can be configured to allow meeting attendees to select whether or not their user notes 135 will be shared with one or more of the other meeting attendees. In another arrangement, the user notes 135 can be shared with one or more of the other meeting attendees unless the attendee who creates the user notes 135 opts out of such sharing.

The virtual meeting module 120 can be configured to convert the user notes 135 from one form of data to another. For instance, user notes 115 received in audio and/or video data formats can be converted to text. To that end, the virtual meeting module 120 can include any known voice recognition, transcription, dictation, speech-to-text or other conversion software.

The virtual meeting module 120 can collect data relevant to the virtual meeting. The data can be collected in any suitable manner by the virtual meeting module 120. For instance, the virtual meeting module 120 can be configured to record at least a portion of the virtual meeting, including the meeting content 140 (e.g., one or more of the audio, video and/or messaging streams). Alternatively or in addition, the virtual meeting module 120 can be configured to collect or receive the user notes 135. The collected data can be stored in the virtual meeting database 130.

The virtual meeting module 120 can be configured to link the user notes 135 to a recording of the virtual meeting. Such linking can be performed in any suitable manner. For instance, the linking can include tagging the user notes 135 as they are made with a timestamp to indicate when each portion of a user note 135 was made. Meeting content 140 within the virtual meeting associated with the timestamp (e.g. recording the audio, video and messaging/chat streams associated with that time stamp) can be recorded. The user notes 135 can be linked or otherwise associated with virtual meeting content 140 having the same timestamp. Such linking can allow quick recall of meeting content 140 occurring during that timestamp.

The system 100 can include an analysis engine 125. The analysis engine 125 can be stored and/or executed on the server 110 and/or the virtual meeting module 120. Alternatively, the analysis engine 125 can be stored and/or executed on another system to which the server 110 and/or the virtual meeting module 120 is communicatively linked. The analysis engine 125 can be implemented as computer readable program code that, when executed by a processor, implement the various processes described herein.

The analysis engine 125 can analyze data collected during a virtual meeting in various ways. For instance, analysis engine 125 can analyze the user notes 135 made by one or more of the meeting attendees. Such analysis can occur in any suitable form. For instance, the analysis engine 125 can analyze the user notes 135 using any known natural language processing system or technique. Natural language processing can includes analyzing each user's notes for topics of discussion, deep semantic relationships and keywords. Natural language processing can also include semantics detection and analysis and any other analysis of data including textual data and unstructured data. Semantic analysis can include deep and/or shallow semantic analysis. Natural language processing can also include discourse analysis, machine translation, morphological segmentation, named entity recognition, natural language understanding, optical character recognition, part-of-speech tagging, parsing, relationship extraction, sentence breaking, sentiment analysis, speech recognition, speech segmentation, topic segmentation, word segmentation, stemming and/or word sense disambiguation. Natural language processing can use stochastic, probabilistic and statistical methods

The analysis engine 125 can perform sophisticated indexing of the user notes 135. The analysis engine 125 can cross-reference the user notes 135 to extract key elements therefrom. A “key element” is a concept, topic, keyword, key phrase or noteworthy point that meets a predetermined threshold of significance. In one implementation, the analysis engine 125 can be configured to identify key elements by detecting commonalities within a single user note 135 or across a plurality of user notes 135. The analysis engine 125 can use the key elements to generate consolidated system notes 145 for later consumption by other meeting attendees or others who wish to have an overview of the meetings core concepts.

At any point during a virtual meeting, one or more meeting attendees can initiate a note taking session. One or more user interface elements can be presented to the virtual meeting attendees to enable a user to initiate note taking. For instance, the user interface element can be a graphical user interface element, such as a button. The user can input a user note in any suitable manner, such as in text, voice and/or video format. The system can automatically collect user notes from the meeting attendees. When a note taking session is initiated, one or more user interface elements can be presented to allow a user to select whether the user notes will be shared with one or more meeting attendees and/or whether the user notes will be designated as confidential.

The user notes 135 and the meeting content 140 (e.g., video stream, audio stream and/or messaging stream) can be monitored. The user notes 135 and/or the meeting content 140 can be saved or recorded in any suitable manner. A timestamp of when the user notes 135 and/or the meeting content 140 was input can be captured. The user notes 135 can be converted, if necessary, to text or a textual representation. The virtual meeting module 120 can consolidate all user notes 135 taken by one or more of the meeting attendees during the virtual meeting. Such consolidation can occur at any suitable point of time, such as after the virtual meeting is finished or as the user notes are made.

The analysis engine 125 can be configured to analyze the user notes 135 input by the meeting attendees. The analysis engine 125 can be configured to perform natural language processing on the user notes 135. For instance, the analysis engine 125 can analyze each user's noted for topics of discussion, deep semantic relationships and keywords that are common across a plurality of notes. Based on such analysis, the analysis engine 125 can index and/or cross-reference the user notes 135 to extract key elements therefrom. For instance, key elements can be extracted using significance scoring based on time spent on the point, the appearance of the point in multiple meeting content streams, commonalities of the notes, etc. One or more key elements may be extracted from the user notes 135 of one meeting attendee in isolation, or one or more key elements may be inferred based on common occurrences of the key element(s) across a plurality of user notes 135. Further, the virtual meeting module 120 can be configured to analyze the semantics of the user notes 135 to detect key elements.

The analysis engine 125 and/or the virtual meeting module 120 can organize the detected key elements in any suitable manner, such as by logical similarity and/or topic. The analysis engine 125 and/or the virtual meeting module 120 can consolidate at least a subset of the detected key elements into consolidated system notes 145. The consolidated system notes 145 can have any suitable form. In one implementation, the consolidated system notes 145 can be grouped under main topics by conceptual similarity using any suitable natural language analysis.

The consolidated system notes 145 can include links back to the associated user notes 135. For example, the consolidated system notes 145 can present key elements that provide links back to the underlying user notes 135 from which the notes were extracted. The linking of the consolidated system notes 145 to the original user notes 135 can include linking the notes to surrounding user notes 135 to provide context. Thus, the linking can include the presentation of sub-notes to a relevant portion of the source material from which the key element was extracted. As an example, a first note from one of the user notes can be related to a second note from a different one of the user notes. The system may consolidate these notes under a single summary note in the consolidated system notes 145. However, the first and second notes can be presented as sub-notes under the summary note.

Each key element may link to individual user notes 135 that relate to that key element. The virtual meeting module 120 may link the user notes 135 and/or key elements to recordings of meeting content 140 that occurred at or near the same time. As an example, the virtual meeting module 120 can tag each of the user notes 135 with a timestamp indicating when each input of the user note 135 was made by the user. The virtual meeting module 120 can record meeting content 140 within the virtual meeting associated with that timestamp, including audio, video, and chat streams. The virtual meeting module 120 can link the user notes 135 with the meeting content 140, allowing quick recall of audio, video, chat and/or other data streams during that time.

The user notes 135 and/or consolidated system notes 145 can be stored in a database, such as meeting database 130. Alternatively or in addition, the user notes 135 and/or the consolidated system notes 145 can be published. “Published” means that the information is made available or accessible for users to consume. The user notes 135 and/or the consolidated system notes 145 can be published to the meeting attendees, or they can be published to one or more non-attendees as well. As an example, the user notes 135 and/or the consolidated system notes 145 can be published by distributing them to a predefined list of recipients, such as by a message (e.g. electronic mail). In one embodiment, the user notes 135 and/or the consolidated system notes 145 can be published to the meeting participants and/or to other interested parties. In such case, the user notes 135 and/or the consolidated system notes 145 can be embedded in the message itself, included as an attachment to the message or the message can provide directions to access the user notes 135 and/or the consolidated system notes 145 (such as a hyperlink or URL). As another example, the user notes 135 and/or the consolidated system notes 145 can be published to an external computing system 150. “External computing system” is any computing system that is external to and/or independent of the virtual meeting. Examples of external computing systems 150 include a social collaboration system or website. Publication of the user notes 135 and/or the consolidated system notes 145 can facilitate convenient review.

FIG. 2 is a flow chart illustrating a method 200 of crowdsourcing and consolidating user notes taken within a virtual meeting in accordance with one embodiment disclosed within this specification. At step 205, user notes from one or more virtual meeting attendees can be received. At step 210, the received user notes can be analyzed to identify a key element therein. Such analyzing can by performed by a processor. At step 215, consolidated system notes can be generated. The consolidated system notes can include the key element.

Examples of implementations of the system 100 will now be presented. In one example, the system 100 can be used in an organization in which a virtual meeting is conducted. For instance, a virtual meeting can be held to present a company's first quarter financial results. The meeting content may include slides which present information, data and content to this topic. The meeting attendees can take user notes during the virtual meeting. The user notes taken by one meeting attendee can be independent of the user notes taken by other meeting attendees.

When particular meeting content (e.g., a particular slide) is shown, one or more meeting attendees may input user notes regarding the slide. For instance, a first meeting attendee may input the following user note: “sales are trending up.” A second meeting attendee may input the following note: ‘sales for the software division are up 8% over last quarter.” A third meeting attendee may input the following note: ‘steady rise in international sales.”

The system can analyze the individual user notes. The system can detect key elements by identifying the commonalities of the user notes. In this instance, the system can automatically identify that the commonality of these separate user notes is that “sales are up.” The system can consolidate these three notes into one consolidated system note that includes all three key elements. The system can continue to do such consolidation for all user notes made in the virtual meeting.

The consolidated system notes can be generated automatically. In some instances, the consolidated system notes may exclude one or more of the individual notes taken during the virtual meeting. For instance, if only one meeting attendee made a user note on a particular point or topic, that user note may be disregarded in the consolidated system notes due to a lack of commonality with any of the other notes on that point or topic taken by the other meeting attendees. Alternatively or in addition, one or more user notes may be disregarded in the consolidated system notes due to a lack of a sufficient level of commonality with other notes on that point or topic input.

The consolidated system notes can be published for others to consume, regardless of whether they attended the virtual meeting. Thus, members of the company who were not able to attend the virtual meeting can review the consolidated system notes to get at least a sense of the key points gleaned by the individuals who did actually attend the virtual meeting. Further, a meeting attendee who may have missed a portion of the virtual meeting (e.g., due to not being able to take notes fast enough, distraction or being been temporarily called away from the virtual meeting) can review the consolidated system notes to obtain key points that they may have missed.

In another example, the system 100 can be used in an educational environment in which a plurality of people digitally or electronically record notes. For instance, the system can be used by a plurality of students attending in a college classroom or lecture. While the note taking of an individual attendee is independent from the other attendees, the system can collect, analyze, and/or consolidate the notes into a single consolidated system note. The consolidated notes can be published for consumption by the attending students for review or for those students who may have missed at least a portion of the lecture.

As noted above, meeting attendees can have the option to decide whether or not to make their user notes available to others. If a meeting attendee designates its notes as being confidential, then the user notes of that meeting attendee can be excluded from inclusion in the consolidated system notes. Further, the user notes of that meeting attendee can also be excluded from analysis to identify a key element.

FIG. 3 is a block diagram illustrating an example of a data processing system 300. System 300 can include at least one processor (e.g., a central processing unit) 305 coupled to memory elements 310 through a system bus 315 or other suitable circuitry. As such, system 300 can store program code within memory elements 310. Processor 305 executes the program code accessed from memory elements 310 via system bus 315 or the other suitable circuitry.

In one aspect, system 300 is implemented as a computer or other programmable data processing apparatus that is suitable for storing and/or executing program code. It should be appreciated, however, that system 300 can be implemented in the form of any system including a processor and memory that is capable of performing and/or initiating the functions and/or operations described within this specification. Further, system 300 can be implemented in any of a variety of different form factors including, but not limited to, a portable device such as a mobile communication device, a tablet computing and/or communication device, a laptop computing device, a desktop computing device, a server, or the like.

Memory elements 310 include one or more physical memory devices such as, for example, local memory 320 and one or more bulk storage devices 325. Local memory 320 refers to RAM or other non-persistent memory device(s) generally used during actual execution of the program code. Bulk storage device(s) 325 can be implemented as a hard disk drive (HDD), solid state drive (SSD), or other persistent data storage device. System 300 also can include one or more cache memories (not shown) that provide temporary storage of at least some program code in order to reduce the number of times program code must be retrieved from bulk storage device 325 during execution.

Input/output (I/O) devices such as a keyboard 330, a display 335, and a pointing device 340 optionally can be coupled to system 300. The I/O devices can be coupled to system 300 either directly or through intervening I/O controllers. One or more network adapters 345 also can be coupled to system 300 to enable system 300 to become coupled to other systems, computer systems, remote printers, and/or remote storage devices through intervening private or public networks. Modems, cable modems, wireless transceivers, and Ethernet cards are examples of different types of network adapters 345 that can be used with system 300.

As pictured in FIG. 3, memory elements 310 can store the virtual meeting module 120 and/or the analysis engine 125. The virtual meeting module 120, being implemented in the form of executable program code, is executed by system 300 and, as such, is considered an integrated part of system 300. Moreover, the virtual meeting module 120, including any parameters and/or attributes utilized by module 120, are functional data structures that impart functionality when employed as part of system 300. The analysis engine 125, being implemented in the form of executable program code, is executed by system 300 and, as such, is considered an integrated part of system 300. Moreover, the analysis engine 125, including any parameters and/or attributes utilized by engine 125, are functional data structures that impart functionality when employed as part of system 300.

The consolidated notes 145 can be output to, and stored within, memory elements 310. As used herein, “outputting” and/or “output” can mean storing in memory elements 310, for example, writing to a file stored in memory elements 310, writing to display 335 or other peripheral output device, playing audible notifications, sending or transmitting to another system, exporting, or the like.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

1-7. (canceled)

8. A system for crowdsourcing user notes taken within a virtual meeting comprising:
a processor programmed to initiate executable operations comprising:
receiving user notes from one or more meeting attendees;
analyzing the received user notes to identify a key element therein using natural language processing; and
generating consolidated system notes that includes the key element.

9. The system of claim 8, wherein analyzing the received user notes to identify a key element therein using natural language processing includes:
analyzing received user notes to identify one or more key elements therein; and
cross-referencing the analyses of the received user notes to identify one or more common key elements in the analyses thereof.

10. The system of claim 8, wherein analyzing the received user notes to identify a key element therein using natural language processing includes indexing the key elements.

11. The system of claim 8, wherein the executable operations further include:
publishing the consolidated system notes.

12. The system of claim 8, wherein the executable operations further include:
linking the key element in the consolidated system notes to a relevant portion of the user notes from which the key element was extracted.

13. The system of claim 8, wherein the executable operations further include:
tagging each of the received user notes with a timestamp to indicate when each user note was taken;
recording meeting content within the virtual meeting associated with the timestamp; and
linking the key element in the consolidated system notes with the associated meeting content within the virtual meeting.

14. The system of claim 8, wherein the executable operations further include:
receiving an input from a meeting attendee to designate the meeting attendee's user notes as being confidential; and
excluding the user notes designated as being confidential from inclusion in the consolidated system note.

15. A computer program product for crowdsourcing user notes taken within a virtual meeting, the computer program product comprising a computer readable storage medium having program code embodied therewith, the program code executable by a processor to perform a method comprising:
receiving, by the processor, user notes from one or more meeting attendees;
analyzing, by the processor, the received user notes to identify a key element therein using natural language processing; and
generating, by the processor, consolidated system notes that includes the key element.

16. The computer program product of claim 15, wherein analyzing the received user notes to identify a key element therein using natural language processing includes:
analyzing received user notes to identify one or more key elements therein; and
cross-referencing the analyses of the received user notes to identify one or more common key elements in the analyses thereof.

17. The computer program product of claim 15, wherein analyzing the received user notes to identify a key element therein using natural language processing includes indexing the key elements.

18. The computer program product of claim 15, wherein the method further includes:
publishing the consolidated system notes.

19. The computer program product of claim 15, wherein the method further includes:
linking the key element in the consolidated system notes to a relevant portion of the user notes from which the key element was extracted.

20. The computer program product of claim 15, wherein the method further includes:
receiving an input from a meeting attendee to designate the meeting attendee's user notes as being confidential; and
excluding the user notes designated as being confidential from inclusion in the consolidated system note.

21. A method of crowdsourcing and consolidating user notes taken within a virtual meeting comprising:
receiving user notes from one or more meeting attendees;
via a processor, analyzing the received user notes to identify a key element therein using natural language processing; and
generating consolidated system notes that include the key element.

22. The method of claim 21, wherein analyzing the received user notes to identify a key element therein using natural language processing includes:
analyzing received user notes to identify one or more key elements therein; and cross-referencing the analyses of the received user notes to identify one or more common key elements in the analyses thereof.

23. The method of claim 21, wherein analyzing the received user notes to identify a key element therein using natural language processing includes indexing the key elements.

24. The method of claim 21, further including publishing the consolidated system notes.

25. The method of claim 21, further including:
linking the key element in the consolidated system notes to a relevant portion of the user notes from which the key element was extracted.

26. The method of claim 21, further including:
tagging each of the received user notes with a timestamp to indicate when each user note was taken;
recording meeting content within the virtual meeting associated with the timestamp; and
linking the key element in the consolidated system notes with the associated meeting content within the virtual meeting.

27. The method of claim 21, further including:
receiving an input from a meeting attendee to designate the meeting attendee's user notes as being confidential; and
excluding the user notes designated as being confidential from inclusion in the consolidated system note.
